(19) United States
(12) Patent Application Publication
(10) Pub. No.: US 2026/0371452 A1
(43) Pub. Date: Nov. 19, 2026

(54) VEHICLE DEFROSTER SYSTEMS AND METHODS

(71) Applicant: Scout Motors Inc., Tysons, VA (US)

(72) Inventors: Zeljko Deljevic, Plymouth, MI (US); Michael Paulin, South Lyon, MI (US)

(21) Appl. No.: 19/206,760

(22) Filed: May 13, 2025

(51) Int. Cl. H05B 3/86

(52) U.S. Cl. CPC H05B 3/86

(57) ABSTRACT

A vehicle includes a vehicle body having a window opening defined therein and a window slidably coupled to the vehicle body within the window opening. The window configured to be translated between an open position and a closed position. A defroster is coupled to the window. The defroster comprising a grid of resistive wires and an electrical connection system configured to selectively provide power to the defroster. The electrical connection system includes a conductor coupled to the window and the grid of resistive wires, a connector coupled to the vehicle body adjacent the window opening. The connector configured to engage the conductor when the window is in the closed position to provide electrical power to the defroster.

### FIELD OF INVENTION

This disclosure relates to vehicle defroster systems and methods for movable glass. More specifically, this disclosure relates to an electrical connection system for selectively providing power to the defroster.

### BACKGROUND

Many defroster assemblies of the prior art include a permanent electrical connection with electrical cables, which can create issues on movable glass windows. For example, moving the windows may result in excessive cycling of the electrical cables and may result in premature failure of the defroster. The permanent connection also poses packaging challenges, as extra wire length has to have a storage location when the window is lowered. There is a risk that electrical cables may get trapped or pinched as the window moves.

### SUMMARY

In some aspects, the disclosure relates to a vehicle including: a vehicle body having a window opening defined therein and a window slidably coupled to the vehicle body within the window opening. The window configured to be translated between an open position and a closed position. The vehicle also includes a defroster coupled to the window. The defroster comprising a grid of resistive wires and an electrical connection system configured to selectively provide power to the defroster. The electrical connection system comprising a conductor coupled to the window and the grid of resistive wires, and a connector coupled to the vehicle body adjacent the window opening. The connector configured to engage the conductor when the window is in the closed position to provide electrical power to the defroster.

In some aspects, the disclosure relates to a defroster configured to be coupled to a window of a vehicle. The window configured to be slidable between an open position and a closed position. The defroster including: a grid of resistive wires, and an electrical connection system configured to selectively provide power to the defroster. The electrical connection system comprising: a conductor coupled to the window and the grid of resistive wires, and a connector coupled to the vehicle adjacent the window. The connector configured to directly engage the conductor when the window is in the closed position to provide electrical power to the defroster.

In some aspects, the disclosure relates to a vehicle including: a vehicle body having a window opening defined therein and a window slidably coupled to the vehicle body within the window opening. The window configured to be translated between an open position and a closed position. The vehicle also includes a defroster coupled to the window. The defroster comprising a grid of resistive wires and an electrical connection system configured to selectively provide power to the defroster. The electrical connection system comprising: a first conductor coupled to the window and the grid of resistive wires, a second conductor coupled to the window and the grid of resistive wires, a first connector coupled to the vehicle body adjacent the window opening, and a second connector coupled to the vehicle body adjacent the window opening. The second connector being connected to a ground wire. The first connector is configured to engage the first conductor and the second connector is configured to engage the first conductor when the window is in the closed position to provide a closed circuit configuration of the electrical connection system and provide electrical power to the defroster.

This summary is illustrative only and is not intended to be in any way limiting. Other aspects and advantages of the devices or processes described herein will become apparent in the detailed description set forth herein, taken in conjunction with the accompanying figures, wherein like reference numerals refer to like elements.

### BRIEF DESCRIPTION OF DRAWINGS

The methods, apparatuses, and systems are explained in even greater detail in the following drawings. The drawings are merely exemplary and certain features may be used singularly or in combination with other features. The drawings are not necessarily drawn to scale.

FIG. 1 is a front perspective view of a vehicle, according to some implementations.

FIG. 2 is a rear perspective view of the vehicle.

FIG. 3 is a rear view of the vehicle of FIG. 1, illustrating a rear window in a closed position.

FIG. 4 is a rear view of the vehicle of FIG. 1, illustrating the rear window in an open position.

FIG. 5A is a side view of an electrical connection system when the window of the vehicle is in the open position.

FIG. 5B is a side view of the electrical connection system when the window of the vehicle is in the closed position.

FIG. 6 is a front perspective view of another vehicle, according to some implementations.

FIG. 7 is a rear perspective view of the vehicle of FIG. 6.

### DETAILED DESCRIPTION

Following below are more detailed descriptions of concepts related to, and implementations of, methods, apparatuses, and systems of a defroster having an electrical connection system for selectively providing power to a defroster. The figures illustrate exemplary implementations in detail and the present disclosure is not limited to the details or methodology set forth in the description or illustrated in the figures. The terminology used herein is for the purpose of description only and should not be regarded as limiting.

As utilized herein, the term “movable window” means any window on a vehicle that may be adjusted by an operator. For example, the movable window may be any side window or rear window of a vehicle. The term “defroster” may encompass any electrical components that can reduce condensation, frost, or any other type of moisture that is built up on the window. In some implementations, the “defroster” may be referred to as a defogger.

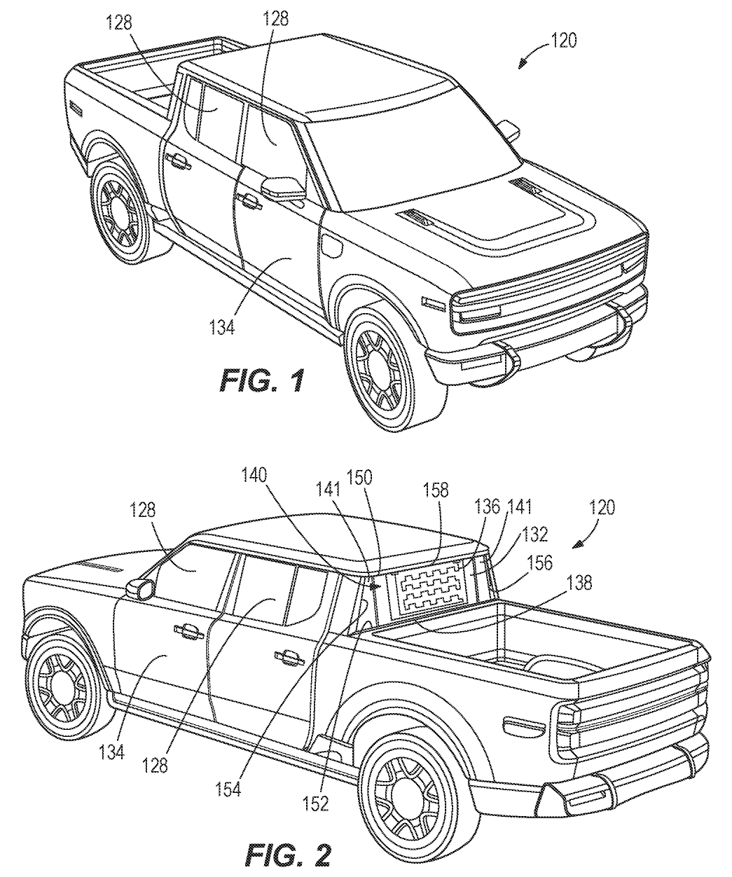

FIGS. 1 and 2 illustrate a vehicle 120 in the form of a sport utility vehicle. The vehicle includes a plurality of side windows 128 and a rear window 132. The windows 128, 132 are slidably coupled to a vehicle body 134 and move between a first, closed position and a second, open position. In the illustrated implementation, the rear window 132 includes a defroster 136 coupled thereto. In some implementations (not shown), the side windows 128 may have a defroster. The vehicle body 134 can include a plurality of side walls (e.g., a driver side wall and a passenger side wall), a rear wall 138 defining a tailgate, and a front end. The rear wall 138 or tailgate of the vehicle body 134 includes a window opening 140. The window opening 140 is configured to receive the rear window 132 such that the rear window 132 covers all or a portion of the window opening 140 in a closed position. In some implementations, the window opening 140 includes one or more fixed glass portions 141. In the illustrated implementation, a pair of fixed glass portions 141 are positioned on each side of the rear window 132. The fixed glass portions may include one or more antennas coupled thereto.

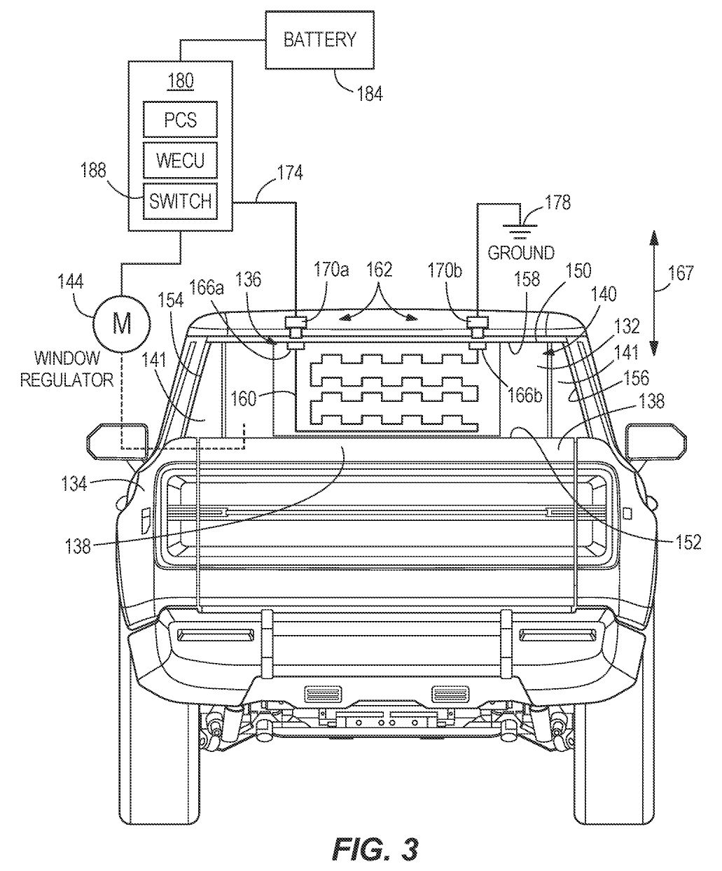

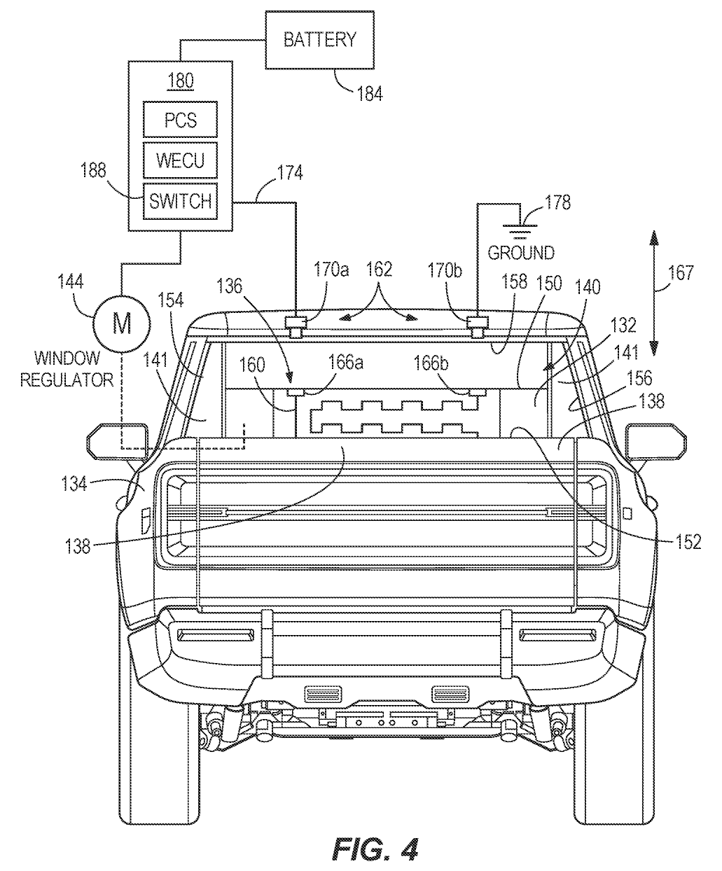

As will be discussed in more detail below, the side windows 128 and the rear window 132 are slidably coupled to surrounding structures of the vehicle body 134. For example, a window regulator 144 (FIGS. 3 and 4) may be operably coupled to each window 128, 132 and are configured to selectively move each window 128, 132 between an open position and a closed position. The windows 128, 132 can be generally rectangular. The windows 128, 132 each include an upper horizontal edge 150, a lower horizontal edge 152, a first side edge 154, and a second side edge 156. In the illustrated implementation, the side edges 156 extend mainly in a vertical direction 167. Also, the windows 128, 132 may include an interior surface and an exterior surface. The interior surface faces the interior area (i.e., the passenger compartment, cargo area, etc.) of the vehicle 120, and the exterior surface is opposite the interior surface. In the closed position, the upper horizontal edge 150 of the window 132 is positioned adjacent an upper edge 158 of the window opening 140.

In the illustrated implementation, the windows 128, 132 are slidably attached to the vehicle body 134. However, it should be appreciated that the rear window 132 could be pivotably or otherwise moveably attached to the vehicle body 134 without departing from the scope of the present disclosure. Further, only the rear window 132 is discussed in detail below, but it should be appreciated that any movable window on the vehicle 120 may include the disclosed defroster 136.

Now with reference to FIG. 3, the defroster 136 is illustrated in detail. The defroster 136 can include a grid of resistive electrical wires 160 that are mounted to (e.g., silkscreened onto) the window 132. In some implementations, one or more wave traps may be coupled to the vehicle body 134 adjacent the defroster 136. The wave traps may be positioned adjacent the upper edge 158 of the window opening 140 and may be used for radio reception purposes. For example, the wave traps reduce conducted interference from the defroster 136 on the rear window 132. The defroster 136 also includes an electrical connection system 162 configured to selectively provide power to the defroster 136. The defroster 136 can be used to reduce condensation, frost, or the like that is built up on the window 132. The window 132 may include other electrical components (e.g., a wiper) coupled thereto. In contrast to systems where the power cable moves with the rear window 132, which requires the wave traps to be mounted to the glass, the disclosed electrical system 162 allows wave traps to be coupled to the vehicle body 134 in a fixed place. In other words, since the defroster 136 is only powered when the rear window 132 is closed, the wave traps can be advantageously coupled to the vehicle body 134.

The electrical connection system 162 includes a pair of conductors 166a, 166b coupled to the window 132 and a pair of contacts 170a, 170b coupled to the vehicle body 134 adjacent the window opening 140. The pair of conductors 166a, 166b are coupled to the grid of resistive electrical wires 160. In some implementations, the conductors 166a, 166b may be a pad coupled to the window 132, incorporated directly into the window 132, or embedded into the window 132. In the illustrated implementation, the conductors 166a, 166b are integrated into the grid of resistive electrical wires 160 of the defroster 136 such that the defroster 136 and the conductors 166a, 166b are formed as a single piece. For example, the defroster 136 and the conductors 166a, 166b may be glued to the rear window 132. In some implementations, a piece of sheet metal may be embedded into the upper horizontal edge 158 of the window 132. The construction of the conductors 166a, 166b allows the conductors 166a, 166b to move with the window 132 as the window 132 retracts within the rear wall 138 of the vehicle body 134 (e.g., the window 132 moves towards an open position). In other words, the conductors 166a, 166b are rigidly coupled to the window 132 and are translatable (e.g., in a vertical direction 167) relative to the upper edge 158 of the window opening 140. For example, the window 132 is only translatable in the vertical direction 167 (e.g., up and down) and does not pivot relative to the rear wall 138.

In the illustrated implementation, the pair of conductors 166a, 166b are supported within the window 132 adjacent the upper horizontal edge 150 of the window 132. In some implementations, the pair of conductors 166a, 166b are exposed on the upper horizontal edge 150 of the window. Coupling the conductors 166a, 166b at different locations (e.g., spaced from each other) allows for the conductors 166a, 166b to separately engage the connectors 170a, 170b. Further, coupling the conductors to the window 132 creates a direct contact point between the conductors 166a, 166b on the window 132 and the connectors 170a, 170b on the vehicle body 134, as described below. In some implementations, the conductors 166a, 166b may be positioned on the same side of the window 132 (e.g., an interior side or an exterior side). In other implementations, the conductors 166a, 166b may be positioned on opposite sides of the window 132 (e.g., one on the interior side and one on the exterior side).

The pair of connectors 170a, 170b are configured to selectively engage the pair of conductors 166a, 166b to electrically connect the defroster 136 to a control system 180, which provides electrical power to the defroster 136. In the illustrated implementation, the pair of connectors 170a, 170b are housed within the rear wall 138 of the vehicle body 134 adjacent the upper edge 158 of the window opening 140. As such, when the window 132 is in the closed position (FIG. 3), the conductors 166a, 166b on the upper horizontal edge 150 of the window 132 engage the connectors 170a, 170b. In other implementations, the conductors 166a, 166b may be coupled to the side edges 154, 156 of the window 132. In such an implementation, the connectors 170a, 170b may be coupled to side walls of the window opening 140 such that the conductors 166a, 166b engage the connectors 170a, 170b when the window 132 is in the closed position.

In the illustrated implementation, the first connector 170a is electrically connected to the control system 180 and a power source 184 (e.g., a battery) via an electrical wire 174 and the second connector 170b is coupled to a ground wire 178, which is creates a return path for electrical current. Therefore, when the window 132 is closed (FIG. 3), the first conductor 166a contacts the first connector 170a and the second conductor 166b contacts the second contact 170b to automatically connect (the defroster 136 to the control system 180 and the power source 184. For example, the connection between the conductors 166a, 166b and the connectors 170a, 170b creates a closed circuit configuration. In the illustrated implementation, the conductors 166a, 166b on the window 132 directly contact the connectors 170a, 170b formed on the vehicle body 134.

When the window 132 moves from the closed position (FIG. 3) to an open position (FIG. 4), the conductors 166a, 166b move out of contact with the connectors 170a, 170b. Disconnecting the conductors 166a, 166b automatically restricts power to the defroster 136 (e.g., electrically disconnects the defroster 136) from the power source 184. The disconnection of the conductors 166a, 166b and the connectors 170a, 170b creates an open circuit configuration to electrically disconnect the defroster from the power source 184. Due to the construction of the electrical connection system 162, the wiring (e.g., electrical wire 174 and ground wire 178) remain fixed or stationary within the vehicle body 134. Therefore, no wiring is required to move with the window 132 when it operates. This avoids extra stress on the wiring (e.g., electrical wire 174 and ground wire 178) and connectors 170a, 170, which leads to less wear on the electrical connection system 162 and less wiring required. Further, the stationary contacts 170a, 170b do not require space within the vehicle body 134 for a wire harness to travel with the window 132, which makes the electrical connection system 162 less susceptible to the wiring being caught or damaged during movement of the window.

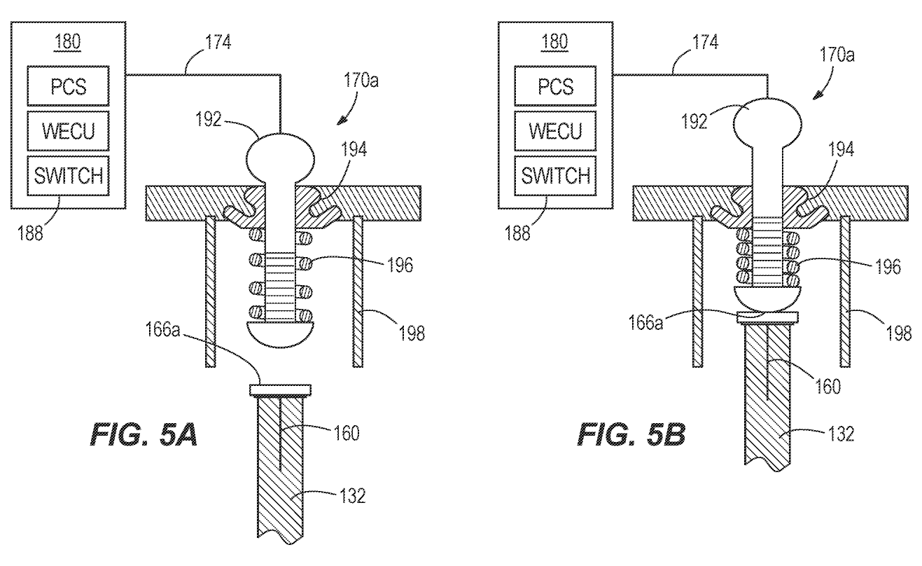

FIGS. 5A and 5B, illustrates the connector 170a in more detail. While the connector 170b is not illustrated in detail in FIGS. 5A and 5B, it should be appreciated that the connector 170b may have a similar construction to the connector 170a. The connector 170a is a spring-loaded contact. In some implementations, the connector 170a is a pogo pin having a plunger 192 movably coupled to a barrel 194 and a spring 196 (e.g., a coil spring, a compression spring, or the like) that urges the plunger 192 to an extended position (FIG. 5A). In the extended position, the connectors 170a, 170b supported within the vehicle body 134 are electrically insulated from the power source 184 such that no voltage is exposed. The plunger 192 is in the extended position when the window 132 is in the open position (FIG. 5A). In contrast to spring loaded arch or leaf solutions, the construction of the connector 170a reduces the wear of the electrical connection system 162 over time. In particular, spring-loaded arch or leaf solutions may wear out faster, loosen, or be prone to accidentally making minor contact, which could inadvertently close the electrical circuit.

In some implementations, the connectors 170a, 170b are recessed within the vehicle body 134. A protective structure 198, for example a wall, extends on each side of the connector 170a, 170b. The protective structure 198 is configured to prevent an operator from accidentally actuating the plunger 192 manually when the window 132 is in the open position. In some implementations, the protective structure 198 is a window seal extending along the upper horizontal edge 150 of the window. The window seal may separate the connectors 170a, 170b to prevent the operator from touching the connectors 170a, 170b and/or exposing the connectors 170a, 170b to external elements (e.g., rain, dirt, or the like). When the window 132 is in the closed position (FIG. 5B), the conductor 166a on the window 132 engages the plunger 192, which electrically connects the grid of resistive electrical wires 160 of the defroster 136 to the power source 184. In other words, the window 132 is configured to move the plunger 192 to a compressed position (FIG. 5B) when the window is translated to the closed position. When the plunger 192 is in the compressed position an electrical connection is made with the defroster 136.

Now with reference to FIG. 3, the control system 180 may include one or more electronic control units (ECUs), each of which are dedicated to a specific function or set of functions. Each ECU may be a computer system and each ECU may include functionality provided by one or more of the example ECUs described below. For example, the control system 180 may include a window control ECU (WECU) and a user input controller ECU (referred to as a “UIC”). The WECU is operably coupled to the power source 184, the window regulator 144, and the defroster 136. The UIC may receive user inputs and/or transmit information/feedback to a user. For example, the UIC may receive inputs from the operator related to operation of the window 132 and/or the defroster 136 and/or transmit feedback related to the window 132 and/or the defroster 136 to the operator. For example, the WECU is configured to receive a signal related to the status of the window 132 (e.g., open or closed) and the status of the defroster 136 (e.g., activated or deactivated). In some implementations, the status of the window 132 and the defroster 136 may be transmitted to the operator via the UIC.

In some implementations, the control system 180 may include a switch 188 configured to selectively provide power to the defroster 136. It should be appreciated, that while the switch 188 is shown as part of the control system 180, that the switch 188 may be positioned in series between the control system 180 and the first connector 170a. In some implementations, the WECU is configured to receive a signal related to the status of the switch 188. In contrast to other defrosters which require a limit switch to be activated by window (e.g., via a physical contact when the window is closed), the control system 180 does not require a limit switch. Rather, the WECU is configured to track the status of the window (e.g., open or closed) and activate or deactivate the switch 188 to selectively provide power to defroster 136 when the window 132 is closed. While only three components of the control system 180 are illustrated in detail, it should be understood that the control system 180 may include a different number and/or combination of ECUs (e.g., additional ECUs, fewer ECUs, etc.). Further it should be appreciated that the WECU and the UIC communicate with either other to control movement of the window 132 and the defroster 136.

During operation of the window 132, the operator may provide an input to the UIC to open the window 132. The UIC sends a signal to the WECU related to movement of the window 132 and/or operation of the defroster 136. For example, the WECU provides a command to a switch 188 to turn off power to the defroster 136 and may provide a signal to the window regulator 144 to translate the window 132 to an open position (FIG. 4). In some implementations, the switch 188 is in series with the electrical wire 174 to selectively restrict power to the first connector 170a. Restricting power to the first connector 170a turns off the defroster 136. Turning off the power to the defroster 136 prior to opening the window 132 reduces the likelihood of micro-arcing between the connectors 170a, 170b, the conductors 166a, 166b, or the surrounding areas. For example, if power is not turned off, micro-arcing between the components may result in melting, damage, or the like to the connectors 170a, 170b and the conductors 166a, 166b. In some implementations, turning off the power to the connector 170a with the switch 188 also ensures there is no exposed voltage on the connector 170a when the window 132 is open.

When the window 132 is returned to the closed position (FIG. 3) from the open position, the operator may provide an input to the UIC to close the window 132. The UIC sends a signal to the WECU related to movement of the window 132 and/or operation of the defroster 136. The WECU may provide a signal to the window regulator 144 to translate the window 132 to the closed position. In some implementations, the WECU may provide a command to the switch 188 to turn on the power to the defroster 136. For example, if the defroster 136 was on prior to the window 132 being opened, the WECU may automatically provide power to the defroster 136 when the window 132 is closed. If the defroster 136 was off prior to the window 132 being opened, the WECU may continue to restrict power to the defroster 136 when the window 132 is closed. It should be appreciated that while the defroster 136 is described in detail, that one or more electrical components packaged within the window 132 may be coupled to the power source 184 via the electrical connection system 162 in a similar fashion. For example, the one or more electrical components may include antennas, radios, cameras, or the like.

In some implementations, the UIC may provide feedback to the operator (e.g., via an infotainment system or the like) related to the status of the window 132 and/or the defroster 136. For example, the UIC may indicate that the defroster 136 is turned on, turned off, or turned off due to the window 132 being open. In addition, if the operator provides an input to turn on the defroster 136 when the window 132 is open, the UIC may provide an indication that the defroster 136 is unable to be turned on. Alternatively, if the operator provides the input to turn on the defroster 136 when the window 132 is open, the WECU may automatically close the window 132 and provide power to the defroster 136 once the window 132 returns to the closed position.

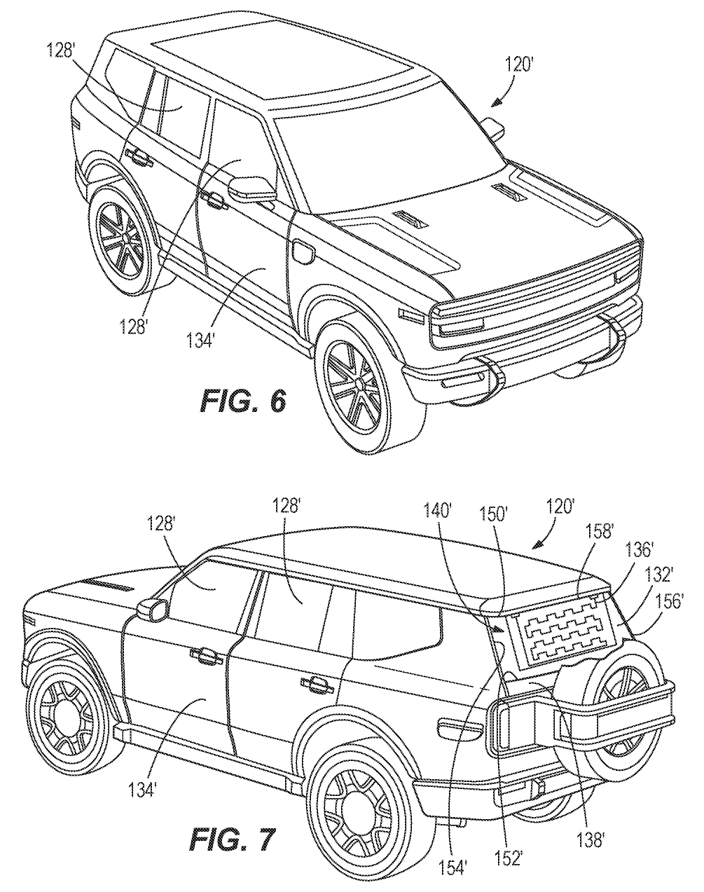

FIGS. 6 and 7 illustrate a vehicle 120’ in the form of a pickup truck. The vehicle includes a plurality of side windows 128’ and a rear window 132’. The vehicle body 134’ can include a plurality of side walls (e.g., a driver side wall and a passenger side wall), a truck bed, a rear wall 138’, and a front end. It should be appreciated that the rear wall 138’ defines a rear end of the passenger compartment of the vehicle 120’. The rear wall 138 includes the rear window 132’.

Features discussed above with respect to the vehicle 120, can be implemented on the vehicle 120’, or another type of vehicle (e.g., a van) as desired. As such, it should be understood that the disclosure is equally applicable to the vehicle 120, 120’ or other vehicles. For example, the vehicle 120, 120’ may be a pure-electric vehicle, a hybrid electric vehicle (e.g., a series hybrid vehicle, a range extended electric vehicle (REEV), an extended-range electric vehicle, etc.), and/or a plug-in electric vehicle.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As discussed above, the disclosed defroster 136 provides multiple advantages over defrosters of the prior art. In particular, the construction of the electrical connection system 162 allows the wiring (e.g., electrical wire 174 and ground wire 178) to remain fixed or stationary within the vehicle body 134. Therefore, no wiring is required to move with the window 132 when it operates. This avoids extra stress on the wiring and connectors 170a, 170, which leads to less wear on the electrical connection system 162 and less wiring required. Further, the stationary contacts 170a, 170b do not require space within the vehicle body 134 to permit the wire harnesses to travel with the window 132, which makes the electrical connection system 162 less susceptible to the wiring being caught or damaged during movement of the window 132. Further, the wave traps must be mounted to the glass in systems where the power cable moves with the rear window 132. In contrast, the disclosed electrical system 162 allows the wave traps to be coupled to the vehicle body 134 in a fixed place. In other words, since the defroster 136 is only powered when the rear window 132 is closed, the wave traps can be advantageously coupled to the vehicle body 134 instead of the window.

The disclosed defroster 136 also provides numerous advantageous over hinged hatchback style windows using contactors. Due to the construction of the hinged windows, the contacts are exposed when the window is open and the contacts cannot be recessed within the vehicle body (e.g., in the upper horizontal edge 150 of the window opening). This construction provides the risk of live voltage being exposed when an operator touches one of the contacts. For example, if an operator pushes the contactor, the contactor may provide a spark, short the circuit, or shock the operator. Further, the hatchback window may be opened manually by the operator. Therefore, there is no opportunity for power to the defroster to be restricted or deactivated prior to manually opening the window, which may cause micro-arching between the components of the defroster. In addition, the hinged connection of the window typically requires wires to connect across a gap adjacent the hinged connection, which can produce additional strain on the wires (e.g., curled wires). Lastly, hinged windows are formed of a single glass pane. Therefore, antennas, wave traps, and the like have to be integrated into the window. In contrast, the disclosed defroster 136 allows the antennas to be integrated into a fixed glass portion 141 and the wave traps to be supported on the vehicle body 134.

As used in the specification and the appended claims, the singular forms “a”, “an”, and “the” include plural referents unless the context clearly dictates otherwise.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Certain terminology is used in the following description for convenience only and is not limiting. The words “right”, “left”, “upper”, and “lower” designate direction in the drawings to which reference is made. The words “inner” and “outer” refer to directions toward and away from, respectively, the geometric center of the described feature or device. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. A vehicle comprising:
a vehicle body having a window opening defined therein,
a window slidably coupled to the vehicle body within the window opening, the window configured to be translated between an open position and a closed position; and
a defroster coupled to the window, the defroster comprising a grid of resistive wires and an electrical connection system configured to selectively provide power to the defroster, the electrical connection system comprising:
a conductor coupled to the window and the grid of resistive wires, and
a connector coupled to the vehicle body adjacent the window opening, the connector configured to engage the conductor when the window is in the closed position to provide electrical power to the defroster.

2. The vehicle of claim 1, wherein the window opening includes an upper edge, and wherein the conductor is translatable with the window relative to the upper edge when moving to the open position.

3. The vehicle of claim 1, wherein the conductor is adjacent an upper horizontal edge of the window, and wherein the connector is coupled to the vehicle body adjacent an upper edge of the window opening.

4. The vehicle of claim 3, wherein the conductor is exposed on the upper horizontal edge of the window.

5. The vehicle of claim 1, wherein a direct contact point is formed between the conductor and the connector.

6. The vehicle of claim 1, wherein the connector is electrically connected to a control system and a power source via an electrical line, and wherein the control system is configured to turn off power to the defroster prior to opening the window.

7. The vehicle of claim 6, further comprising a switch in communication with the electrical line to selectively restrict power to the connector, and wherein restricting power to the connector turns off the defroster.

8. The vehicle of claim 1, wherein:
the conductor is a first conductor,
a second conductor is coupled to the window and the grid of resistive wires,
the connector is a first connector,
a second connector is coupled to the vehicle body adjacent the window opening, and
a ground wire is connected to the second connector.

9. The vehicle of claim 1, wherein the connector includes a plunger movably coupled to a barrel and a spring that urges the plunger to an extended position, and wherein the connector is electrically insulated in the extended position.

10. The vehicle of claim 9, wherein the window is configured to move the plunger to a compressed position when the window is translated to the closed position, and wherein when the plunger is in the compressed position an electrical connection is made with the defroster.

11. The vehicle of claim 10, further comprising a protective structure extending on each side of the connector, and wherein the protective structure is configured to prevent an operator from actuating the plunger when the window is in the open position.

12. A defroster configured to be coupled to a window of a vehicle, the window configured to be slidable between an open position and a closed position, the defroster comprising:
a grid of resistive wires; and
an electrical connection system configured to selectively provide power to the defroster, the electrical connection system comprising:
a conductor coupled to the window and the grid of resistive wires, and
a connector coupled to the vehicle adjacent the window, the connector configured to directly engage the conductor when the window is in the closed position to provide electrical power to the defroster.

13. The defroster of claim 12, wherein the conductor is exposed on an upper horizontal edge of the window.

14. The defroster of claim 12, wherein the connector is electrically connected to a control system and a power source via an electrical line, and wherein the control system is configured to turn off power to the defroster prior to opening the window.

15. The defroster of claim 14, further comprising a switch in communication with the electrical line to selectively restrict power to the connector, and wherein restricting power to the connector turns off the defroster.

16. The defroster of claim 12, wherein:
the conductor is a first conductor,
a second conductor is coupled to the window and the grid of resistive wires, the second conductor offset the first conductor on the window,
the connector is a first connector,
a second connector is coupled to the vehicle offset the first connector,
a ground wire is connected to the second connector, and
when the window is translated to the closed position, the first and second conductors are respectively aligned with the first and second connectors to provide a closed circuit configuration of the electrical connection system.

17. The defroster of claim 12, wherein the connector includes a plunger movably coupled to a barrel and a spring that urges the plunger to an extended position, and wherein the connector is electrically insulated in the extended position.

18. A vehicle comprising:
a vehicle body having a window opening defined therein,
a window slidably coupled to the vehicle body within the window opening, the window configured to be translated between an open position and a closed position; and
a defroster coupled to the window, the defroster comprising a grid of resistive wires and an electrical connection system configured to selectively provide power to the defroster, the electrical connection system comprising:
a first conductor coupled to the window and the grid of resistive wires,
a second conductor coupled to the window and the grid of resistive wires,
a first connector coupled to the vehicle body adjacent the window opening, and
a second connector coupled to the vehicle body adjacent the window opening, the second connector being connected to a ground wire,
wherein the first connector is configured to engage the first conductor and the second connector is configured to engage the first conductor when the window is in the closed position to provide a closed circuit configuration of the electrical connection system and provide electrical power to the defroster.

19. The vehicle of claim 18, wherein the window opening includes an upper edge, and wherein the first and second conductors are translatable with the window relative to the upper edge when moving to the open position.

20. The vehicle of claim 18, wherein the first and second conductors are exposed on an upper horizontal edge of the window, and wherein the first and second connectors are coupled to the vehicle body adjacent an upper edge of the window opening.
